(19) United States
(12) Patent Application Publication
(10) Pub. No.: US 2023/0362831 A1
(43) Pub. Date: Nov. 9, 2023

(54) POWER COMPENSATION METHOD AND APPARATUS EMPLOYING WHITE SPACE OPTIMIZATION AND UTILIZATION TECHNOLOGY

(71) Applicant: ANYWAVE COMMUNICATION TECHNOLOGIES CO., LTD., Changshu (CN)

(72) Inventors: Jingsong XIA, Hawthorn Woods, IL (US); Wenhua LI, Lincolnshire, IL (US); Bowei SONG, Changshu (CN); Yingying FAN, Changshu (CN)

(21) Appl. No.: 17/998,666

(22) PCT Filed: Aug. 8, 2021
(86) PCT No.: PCT/CN2019/099694

§ 371 Date: Nov. 13, 2022

(30) Foreign Application Priority Data
Jul. 15, 2019 (CN) 201910634899.5

(51) Int. Cl. H04W 52/24

(52) U.S. Cl. CPC H04W 52/243

(57) ABSTRACT

A power compensation method and apparatus based on white space optimization and utilization technology comprises: obtaining an available white space channel; and respectively and correspondingly compensating upper adjacent channels and/or lower adjacent channels of the white space channel according to the overlaps between the coverage of a white space device and the coverage of authorized adjacent channels signals, such that the white space device can obtain the maximum number of selectable channels and the maximum transmission power without affecting the authorized signals currently used in the adjacent channels; it is used to respectively enhance the output power of authorized signals in adjacent channels of a white space channel, such that a white space device operating at the white space channel can meet the predetermined requirements of transmission power and coverage without adversely affecting the coverage and reception of authorized signals currently used in the adjacent channels.

### TECHNICAL FIELD

The present invention relates to a technology in the field of wireless communication, in particular to a power compensation method and apparatus based on white space optimization and utilization technology.

### BACKGROUND ART

TV white space (TVWS for short) refers to those wireless spectrums that have been allocated to broadcast television but have not been occupied by a certain television broadcaster or other authorized users in a specific time and space. At present, the use of white space is often limited by its adjacent channel interference and environmental restrictions on the transmission power of white space.

The prior arts often solve the above limitations by adjusting the power, but generally due to the factors such as site conditions, especially the physical spacing of the antenna positions, interference between signals is prone to occur, and part of the noise will also be amplified at the same time, resulting in the final effective signal quality has no improvement.

### SUMMARY OF THE INVENTION

Aiming at the defects that the existing white space utilization technology cannot meet the established requirements in the terms of frequency selection, coverage, output power, etc., the present invention proposes a power compensation method and apparatus based on the white space optimization and utilization technology. By enhancing the output power of the TV broadcast or other authorized signals running at the adjacent channels of the white space frequency, it allows the white space device running at the white space frequency to meet the predetermined output power and coverage requirements without deteriorating the coverage and reception of the existing adjacent channel authorized signals.

The present invention is achieved through the following technical solutions:
The present invention relates to a power compensation method based on white space optimization and utilization technology, characterized in that by obtaining usable white space frequencies, and respectively enhancing the upper and/or lower adjacent channel authorized signals according to the relationship between the coverage of the white space device and its adjacent channel authorized signals, so that the white space device can reach the most of selectable frequencies and the maximum output power without affecting the existing adjacent channel authorized signals.
The upper and/or lower adjacent channels include any N+m/N−m channels corresponding to white space frequency F_{N}, where N is the channel number of the white space frequency, and m is an integer greater than or equal to 1; preferably it refers to the N+1 and N−1 channels that come with a greater influence from the white space frequency F_{N}. For the receiving device, it also refers to the N+1/N−1 channels.

The present invention specifically includes:
The first step is the design and planning stage of white space device: According to application requirements, plan the intended coverage, transmitting point information, and Effective Isotropic Radiated Power (EIRP for short) of the white space device;
The white space device includes but is not limited to: LTE base station or its user equipment, 802.11a/f, 802.22 super Wi-Fi based base station, and its user equipment, etc.

The transmitting point information includes: specific geographic location, erection height, antenna gain, type, and pattern.

The Effective Isotropic Radiated Power EIRP=P−Loss+G, where: P is the output power of the white space device (unit:dBm), Loss is the transmission line loss between the output of the white space device and the antenna feed (unit:dB), G is the transmit gain of the antenna of the white space device (unit:dB).

The second step is to query the local spectrum utilization database according to the transmitting point information of the white space device to obtain a list of available white space frequencies.

2.1) When there is a corresponding EIRP threshold for each available white space frequency in the list, select any available white space frequency F_{N} whose EIRP threshold is greater than the intended transmission power; when all the frequencies' thresholds are lower than the intended transmission power, then choose one whose threshold is the closest to the intended transmission power; when all the available white space frequencies in the list have no EIRP threshold pre-defined, then choose any white space frequency and use the intended transmission power as the EIRP threshold.

The said “greater than the intended transmission power” means that there is at least one channel whose EIRP threshold is higher than the intended transmission power. For example, if the intended transmission power is 15 w, and there are three channels in the list whose EIRP thresholds are 16 w, 18 w, and 20 w respectively. Since all three thresholds are higher than 15 w, so, any of the three channels can be selected as the white space channel.

The said “less” but “closest to” means that all EIRP thresholds are lower than the intended transmission power. For example, if the intended transmission power is 25 w, and there are three available channels whose respective EIRP thresholds are 16 w, 18 w, and 20 w, then all three are less than the intended 25w, so select the channel that has the closest EIRP threshold as the white space channel, in this case, its EIRP is 20 w.

2.2) Before transmitting the signal at the white space frequency F_{N}, measure the noise floor (Noise_{N}, unit:dBm) in the entire channel bandwidth of the channel N, if the difference between the EIRP_{N} and Noise_{N} is greater than or equal to the white space device reception threshold TH_{N} plus a reception margin M_{N}, then it is determined that the current white frequency F_{N} is useable, otherwise, repeat steps 2.1 and 2.2 until a useable frequency is selected.

The reception margin is usually determined based on engineering experience, where the urban environment, obstacles within the visible distance, and the intended coverage area all affect the value of the reception margin. The denser the city, the more obstacles, and the larger the intended coverage area, the greater the reception margin that needs to be reserved.

2.3) The white space device then uses the frequency F_{N} to test the intended coverage area with the intended effective omnidirectional radiation power EIRP_{N} at the predetermined emission point.

The third step is to detect whether there are authorized signals in the adjacent channels F_{N+m} and F_{N-m} of the white space frequency F_{N} at the emission point of the white space device, and compare the authorized coverages of the authorized signals on the adjacent channels with that of the white space device:
3.1) When there is no overlap between the transmission coverage of the white space device and the authorized coverage of the adjacent channel signals, there is no need to enhance the adjacent channel authorized signals;
3.2) When there is an overlap between the transmission coverage of the white space device and the authorized coverage of the upper adjacent channel and/or the lower adjacent channel authorized signal, then the adjacent channel compensation device shall be used to reasonably enhance the upper and/or lower adjacent channel authorized signals, and the enhancement of the EIRP_{N+m} of the upper and/or the EIRP_{N-m}, of the lower adjacent channels should satisfy: choose the larger of Condition A and Condition B as the EIRP_{N+m} and EIRP_{N-m}'S lower limit, and choose the smaller of the condition C and Condition D as the EIRP_{N+m} and EIRP_{N-m}'S upper limit;
   a. EIRP_{N+m} and EIRP_{N-m}'S lower limits should satisfy: EIRP_{N+m}−EIRP_{N}≥R_{D/U-N+m} and EIRP_{N-m}−EIRP_{N}≥R_{D/U-N-m}, that is EIRP_{N+m}≥EIRP_{N}+R_{D/U-N+m}, EIRP_{N-m}≥EIRP_{N}+R_{D/U-N-m}, where EIRP_{N} is the Effective Isotropic Radiated Power of the white space device at channel F_{N} (unit:dBm), R_{D/U-N+m} and R_{D/U-N-m} is the threshold of the desired-to-undesired signal ratio that the receiver can resist against noise as defined in the corresponding standard for adjacent channel authorized signals (unit:dB). The threshold defines the maximum dB allowed for the desired signal to be less than the undesired signal.
   b. EIRP_{N+m} and EIRP_{N-m}'S lower limits should also satisfy: EIRP_{N+m}−P_{aj-N+m}≥TH_{N+m}, and EIRP_{N-m}−P_{aj-N-m}≥TH_{N-m}, that is EIRP_{N+m}≥P_{aj-N+m}+TH_{N+m} and EIRP_{N-m}≥P_{aj-N-m}+TH_{N-m}, where: P_{aj-N+m} and P_{aj-N-m} are the power (unit:dBm) leaked to its upper and lower adjacent channels by the white space device, which satisfies P_{aj-N+m}=EIRP_{N}−L_{N+m}; P_{aj-N-m}=EIRP_{N}−L_{N-m}, EIRP_{N} is Effective Isotropic Radiated Power of the white space device at channel F_{N} (unit:dBm), L_{N+m} and L_{N-m} is the reduction value (unit:dB) of the leakage power of the upper and lower adjacent channels of the white space device compared to its transmission power at the white space frequency (unit:dB); TH_{N+m} and TH_{N-m} are the received signal-to-noise ratio thresholds (unit:dB) of the upper and lower adjacent channel authorized signals, respectively.
   c. EIRP_{N+m} and EIRP_{N-m}'s upper limit should satisfy: EIRP_{N}−EIRP_{N+m}≥R_{D/U-N}, and EIRP_{N}−EIRP_{N-m}≥R_{D/U-N}, that is EIRP_{N+m}≤EIRP_{N}−R_{D/U-N}. EIRP_{N-m}≤EIRP_{N}−R_{D/U-N}, where EIRP_{N} is Effective Isotropic Radiated Power of the white space device at channel F_{N} (unit:dBm), R_{D/U-N} is the lower limit of the desired-to-undesired signal ratio that the receiver can resist against noise as defined in the corresponding standard of the white space device. The threshold defines the maximum dB allowed for the desired signal to be less than the undesired signal.
   d. EIRP_{N+m} and EIRP_{N-m}'s upper limit should also satisfy: EIRP_{N+m}≤EIRP_{N}+L_{N+m-1}−TH_{N}; EIRP_{N-m}≤EIRP_{N}+L_{N-m+1}−TH_{N}; where: L_{N+m-1} and L_{N-m+1} is the power ratio of the main signal of the adjacent channels to the interference signal at their adjacent upper/lower adjacent channels, that is, the interference power difference at the white space frequency (unit:dB); EIRP_{N} is Effective Isotropic Radiated Power of the white space device at channel F_{N} (unit:dBm), TH_{N} is the receiving signal-to-noise ratio threshold of the white space device. Since the power levels of the authorized signals of the upper and/or lower adjacent channels are enhanced, the adjacent channel interferences generated to the white space frequency F_{N} are now. P_{aj-N1}=EIRP_{N+m}−L_{N+m-1} and P_{aj-N2}=EIRP_{N-m}−L_{N-m+1}, respectively. These adjacent channel interference P_{aj-N1} and P_{aj-N2} have increased the noise floor of the white space F_{N}. Under the same output power of the white space device, it reduces the received signal-to-noise ratio of the white space device. Therefore, say the threshold of the receiving signal-to-noise ratio of the white space device is TH_{N}, and if it doesn't satisfy: EIRP_{N}−P_{aj-N1}≤TH_{N} or EIRP_{N}−P_{aj-N2}≤TH_{N}, then the white space device will not work properly. So, the upper and lower adjacent channel EIRP upper limit should satisfy: EIRP_{N+m}≤EIRP_{N}+L_{N+m-1}−TH_{N}; EIRP_{N-m}≤EIRP_{N}+L_{N-m+1}−TH_{N}.

The said enhancement is to increase the authorized signals strength of the upper and/or lower adjacent channels through the adjacent channel compensation device to compensate for the adjacent channel interference caused by the additional white space device, to restore or even increase the reception margin of the transmitted signals of the upper and lower adjacent channels in the area.

Preferably, detect the signal strength of the adjacent channel authorized signals in the overlapping area of the intended coverage area of the white space device and that of the adjacent channel authorized signals. When the adjacent channel authorized signals are affected by the emission of the white space device, check the settings and installation of the upper and/or lower adjacent channel compensation device and further increase their EIRP.

Preferably, within the intended coverage area of the white space device, test the reception of the white space device to verify whether the coverage requirements are met: when the intended EIRP has been transmitted, but the intended coverage is still not met, check the white space device's installation and settings, and further reduce the EIRPs of the adjacent channel compensation device and re-detect the overlapping area if needed.

The Said enhancement preferably further performs feedforward removal of interference in the adjacent channel compensation device and the white space device, specifically: the interference signal obtained from the other party independently is used as a reference signal, and after the actual interference signal is recovered and subtracted from the respective baseband signal, it is used for transmission.

The said interference signal obtained includes the method of direct connection of the output of the source of the interference signal, and/or the method of adding a reference receiving antenna toward the source of the interference signal.

The direct connection mode includes at least one of the following:
a. In the adjacent channel compensation device, the coupling output of the transmitted signal of the white space device is connected through a cable to the input of the adjacent channel compensation device as the RF interference reference signal;
b. In the white space device, the coupling output of the transmitted signal of the adjacent channel compensation device is connected through a cable to the input of the white space device as the RF interference reference signal;
c. When there is more than one upper and/or lower adjacent channel compensation device, they are directly connected through respective cables to obtain RF interference reference signals of corresponding adjacent channels.

The method of adding a reference receiving antenna facing the interference signal source includes at least one of the following:
a. Add a reference receiving antenna to the adjacent channel compensation device to obtain the transmitted signal of the white space device, and introduce the transmitted signal into the adjacent channel compensation device as an RF interference reference signal;
b. Add a reference receiving antenna to the white space device to obtain the transmitted signal of the adjacent channel compensation device, and introduce the transmitted signal into the white space device as an RF interference reference signal;
c. When there is more than one upper and/or lower adjacent channel compensation device, the additional reference receiving antennas are used respectively toward the corresponding adjacent channel compensation device to obtain RF interference reference signals of the corresponding adjacent channels.

The recovery of the interference signal refers to the baseband digital signal processing by the local receiving antenna and the reference signal received through the cable or the reference receiving antenna and converted to the digital domain, and the interference signal is recovered through but not limited to the correlation method.

The conversion to the digital domain uses but is not limited to: pre-amplification, automatic gain control, down-conversion, and analog-to-digital conversion.

The subtraction processing refers to: directly subtracting the recovered interference signal from the local baseband digital signal, thereby obtaining an effective baseband digital signal with interference eliminated, converting it to the analog domain, and transmitting the signal out through the adjacent channel compensation device's antenna or the white space device's antenna.

The conversion to the analog domain uses but is not limited to: digital-to-analog conversion, up-conversion, and power amplification processing.

Further preferably, the self-oscillation between the transmitting and receiving antennas can be eliminated by actively detecting the echo in the adjacent channel compensation device, specifically: the echo recovery is obtained through the echo detection module set at the adjacent channel compensation device, and this recovered echo is subtracted from the baseband signal and then converted to the analog domain and output through the transmitting antenna.

Preferably, the horizontal isolation Lh and vertical isolation Lv among the transmitting and receiving antennas of the adjacent channel compensation device and the antenna of the white space device satisfy:
\textcircled{1} Lₕ=22.0+201 g(d₁/λ)−(Gₜ+Gᵣ)+(Dₜ₁+Dᵣ₁), where: 22.0 is the propagation constant; d₁ is the horizontal interval between the transmitting and receiving antennas (m); λ is the working wavelength of the antenna (m); Gₜ, Gᵣ is the gain (unit:dB) of the transmitting and receiving antennas respectively; Dₜ₁ and Dᵣ₁ are the losses caused by the horizontal directivity function of the transmitting and receiving antennas respectively. The specific values can be found in the antenna pattern. When the angle of the transmitting and receiving antennas is 180°, the directivity loss is the front-to-back ratio of the antenna.
\textcircled{2} Lᵥ=28.0+401 g(d₂/λ)—(Gₜ+Gᵣ)+(Dₜ₂+Dᵣ₂), where: 28.0 is the propagation constant; d₂ is the vertical spacing between the transmitting and receiving antennas (unit: in); Dₜ₂ and Dᵣ₂ are the loss caused the vertical directivity of the two antennas and it is similar to the horizontal directivity function.

Preferably, the antennas of the adjacent channel compensation device and the white space device adopt different polarization modes.

Preferably, the receiving antenna and the transmitting antenna of the adjacent channel compensation device adopt different polarization modes.

Further preferably, the receiving antenna and the transmitting antenna of the adjacent channel compensation device, and the antenna of the white space device adopt the method of opening a choke groove on the carrier, applying absorbing material, installing a metal grid band and/or setting a flange around the antenna to reduce the diffraction of the carrier;

Further preferably, the receiving antenna and the transmitting antenna of the adjacent channel compensation device, and the antenna of the white space device all adopt directional antennas, and the directions of the respective antennas are optimized to minimize sidelobe coupling.

The optimization of the directions of the respective antennas specifically refers to the installation of the directional antennas, considering the coverage requirements, and the coverage area allowed, rotating the installation directions of the directional antennas, and monitoring the strength and the signal-to-noise ratio of the signals corresponding to the antennas with test equipment. Then, find the direction that can optimize the signal strength and signal-to-noise ratio, and set the antenna installation direction that way.

The present invention relates to an apparatus to realizing the above method, comprising the interference detection module and the interference cancellation module respectively in the adjacent channel compensation device and the white space device, wherein: the interference detection module in the adjacent channel compensation device/white space device use a direct cable or an additional reference receiving antenna to obtain the RF signals from the transmitting antennas of the white space device or the adjacent channel compensation device as reference signals, while also receive the local baseband digital signal as input, then output the recovered interference signal to the interference cancellation module. The interference cancellation module subtracts the recovered interference signal from the local baseband digital signal and outputs the baseband digital signal with interference eliminated to finally output to the transmitting antenna.

Preferably, the said apparatus further comprises an echo cancellation system in the adjacent channel compensation device, including the echo detection module and the echo cancellation module, wherein: the echo detection module generates the recovered echo signals and sends them to the echo cancellation module; the echo cancellation module subtracts the recovered echo signal from the baseband digital signal, then uses them for further processing and finally output to the transmitting antenna.

The echo detection module adopts the echo detection technology to obtain the recovered echo signal under the current channel circumstance by referring to the transmitted signal and the echo cancellation module's output. The echo detection technology uses but is not limited to: the LMS Algorithm, NLMS algorithm, RLS algorithm, asynchronous correlation, or a combination of them.

### Technical Effect

Compared with the prior arts, the present invention compensates for the adjacent channel interference caused by the additional white space device by adding power compensation device to the adjacent channels of the white space device at the installation location so that it can restore, and even increase the reception margin of the original upper and lower adjacent channel transmission signals in the area. Therefore, the coverage and reception of the upper and lower adjacent channel authorized signals will not be affected by the use of the white space device, and the white space device does not need to back off the transmission power. The method of the invention also defines the upper and lower limits for reasonable enhancement of the adjacent channel compensation device, which not only ensures that the white space device does not deteriorate the adjacent channel coverage and reception, but also ensures that the white space device can still meet the proposed coverage at the preselected white space channel after the adjacent channel compensation device is installed. The invention expands the accessible range of the white space device, increases the number of selectable channels for white space usage, and reduces the limitation of the transmission power of the white space device caused by the upper and lower adjacent channel authorized signals, thereby greatly improving the utilization and availability of the white space. The present invention also defines several methods of how to better improve the strength and signal quality of the received signal of the adjacent channel compensation device and/or the white space device, which can further improve the signal-to-noise ratio of the respective transmission signals, thereby improving the reception and coverage.

### DESCRIPTION OF THE DRAWINGS

FIG. 1 is a schematic diagram showing the overlapping of the intended coverage areas of the white space device and the upper/lower adjacent channels authorized signals in the embodiments;

FIG. 2 is a schematic diagram of the spectrum of the white space device's lower adjacent channel authorized signal before and after the enhancement in the embodiments;

FIG. 3 is a structural diagram of the interference detection module and the interference cancellation module of the adjacent channel compensation device in embodiments 1;

FIG. 4 is a schematic diagram showing that the intended coverage area of the white space device in the embodiments overlaps with its upper or lower adjacent channel authorized coverage areas;

FIG. 5 is a schematic diagram of the spectrum of the white space device's adjacent channel authorized signals before the enhancement in the embodiments;

FIG. 6 is a schematic diagram of the spectrum of the white space device's adjacent channel authorized signals after the enhancement in the embodiments;

FIG. 7 is a structural diagram of the adjacent channel compensation device with an echo cancellation system in the embodiments;

FIG. 8 is a structural diagram of both the echo cancellation system and interference detection/cancellation modules in the adjacent channel compensation device in the embodiments.

### DETAILED DESCRIPTION OF THE INVENTION

### Embodiment 1

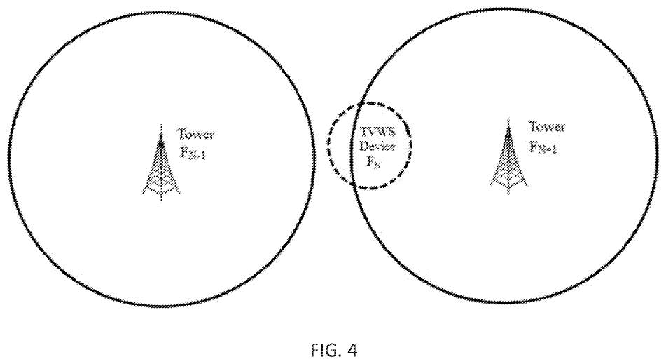

This embodiment relates to a power compensation method based on white space optimization and utilization technology. The application environment is shown in FIG. 4. The white space device is to be installed in the authorized coverage area of the television broadcasting transmitter running at its lower adjacent channel.

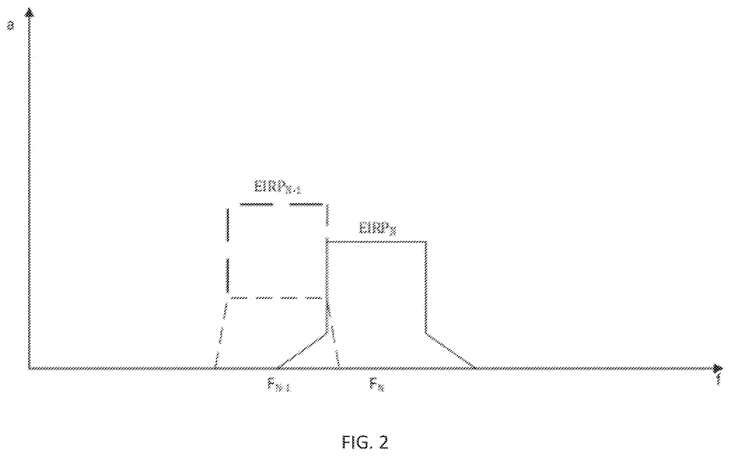

This embodiment specifically includes the following steps:
Step 1. According to the application, it is necessary to realize the signal coverage of the white space device within the dashed circular area shown in FIG. 4. In this embodiment, the white space device is LTE user equipment (UE), the radius of the dashed circular area is 200 meters, the LTE user equipment is installed at the center of the circle, the planned effective omnidirectional radiation power is EIRP=0.2 w (i.e., 23 dBm), and the proposed antenna height is 10 meters.
Step 2. According to the above LTE user equipment installation information, find the white space channel in the known spectrum utilization database that can be used here, for example, CH31, and the corresponding maximum power can be 40 dBm according to local regulations, then the transmission power can be maintained as 23 dBm as intended. At the installation point of LTE user equipment, measure the noise floor due to its adjacent channel signal transmission, and it is −80 dBm. Knowing that the intended transmission power of LTE user equipment is 23 dBm, the engineering design reception margin is 20 dB, and the reception threshold is −3 dB, then 23 dBm−(−80 dBm)=103 dB>−3 dB+20 dB, so it is determined the reception of the intended coverage area of LTE user equipment will not be affected by the noise caused by its adjacent channel, thus confirming that the white space channel CH31 is usable. Set up LTE user equipment here, and conduct a trial transmission at 23 dBm to cover the intended coverage area.
Step 3. From FIG. 4, it can be seen that the intended coverage area of the LTE user equipment is within the authorized coverage area of its adjacent channel CH30 TV broadcast signal transmitter (corresponding to the solid circle whose center has a TV tower logo in FIG. 4). There is no overlap with the authorized coverage of the other adjacent channel CH32. In this embodiment, only one adjacent channel CH30 needs to be reasonably enhanced. The upper and lower limits for the reasonable enhancement are determined step by step as follows:
   a. According to the formula EIRP_{N-m}≥EIRP_{N}+R_{D/U-N-m}, in this embodiment, R_{D/U-N-m} is −35 dB and EIRP_{N}=23 dBm, so the lower limit of EIRP_{N-m} is at least 23 dBm-35 dB=−12 dBm.
   b. According to the formula EIRP_{N-m}≥P_{aj-N-m}+TH_{N-m}, where P_{aj-N-m}=EIRP_{N}−L_{N-m}, in this embodiment EIRP_{N}=23 dBm, L_{N-m}=30 dB, TH_{N-m}=16 dB, then P_{aj-Nm}=−7 dBm; EIRP_{N-m}≥−7 dBm+16 dB=9 dBm, so the lower limit of EIRP_{N-m} is at least 9 dBm.
   c. According to the above steps 1) and 2), confirm that the EIRP of the compensation device of CH30 should not be less than 9 dBm.
   d. According to the formula EIRP_{N-m}≤EIRP_{N}−R_{D/U-N}, in this embodiment. R_{D/U-N} is −30 dB and EIRP_{N}=23 dBm, so the upper limit of EIRP_{N-m} is at most 23 dBm+30 dB=53 dBm.
   e. According to the formula EIRP_{N-m}≤EIRP_{N}+L_{N-m+1}−TH_{N}; where in this embodiment, EIRP_{N}=23 dBm, L_{N-m+1}=45 dB, TH_{N}=−3 dB, and the upper limit of EIRP_{N-m} is at most 23 dBm+45 dB−(−3 dB)=71 dBm.
   f. According to the above steps 4) and 5), confirm that the EIRP of the CH30 compensation device cannot exceed 53 dBm at most.
   g. According to the above steps 1) to 6), the ranges of the transmission power can be obtained. In practical applications, it should be flexibly adjusted according to the needs, and a sufficient margin should be guaranteed. Finally, in this embodiment, the EIRP of the CH30 compensation device is selected as 33 dBm, as shown in FIG. 2.
   h. Add a CH30 power compensation device at the LTE user equipment installation. In this embodiment, an on-channel repeater is used to achieve the compensation. The on-channel repeater receives the RF signal from the CH30 main tower, amplifies the received signal, and then uses the transmitting antenna to transmit the enhanced signal at the CH30 with the EIRP of 33 dBm to realize the power compensation of CH30 in this area.

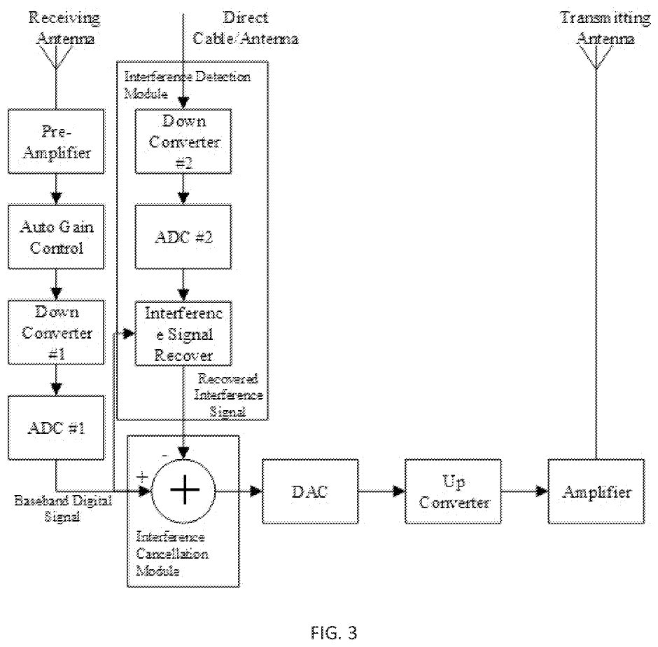

As shown in FIG. 3, in this embodiment, an interference detection module and an interference cancellation module are added to the adjacent channel compensation device of CH30 and the LTE user equipment of CH31 respectively, where: the interference detection module in the adjacent channel compensation device and the LTE user equipment receive their local baseband digital signals and also obtain the transmitted signals as reference from the LTE user equipment and the adjacent channel compensation device respectively by adding reference receiving antennas toward the other device's transmitting antennas. Then by cross-correlation operation, it obtains the recovered interference signal and sends it to the interference cancellation module, while in the interference cancellation module, it subtracts the recovered interference signal from the local baseband digital signal so that it can output signals with interference eliminated for further process and transmission.

When setting up the adjacent channel compensation device of CH30 and the LTE user equipment of CH31, to reduce the signal interference between each other as much as possible, the following methods can be adopted when setting up each other's transmitting and receiving antennas: 1) Design the transmitting antenna of the CH31 LTE user equipment to be horizontally polarized, the transmitting antenna of the CH30 adjacent channel compensation device is designed to be vertically polarized, and its receiving antenna is designed to be horizontally polarized; 2) The antenna of the CH31 LTE user equipment is at least 5 meters higher in vertical distance than the transmitting antenna of the CH30 adjacent channel compensation device. The transmitting antenna of the CH30 adjacent channel compensation device is at least 5 meters higher in vertical distance than the receiving antenna of the CH30 adjacent channel compensation device; 3) Put an absorbing material or metal grid strip on the antennas which can usually get 10-15 dB decoupling. Plus, a choke groove or flange in the antenna can also be decoupled by 5-7 dB. These methods are combined to further reduce the coupling between antennas; 4) First install the antenna of the LTE user equipment according to the coverage requirements and installation plan; then when install the CH30 adjacent channel compensation device receiving antenna, adjust it toward the direction of the CH30 main signal that the CH30 adjacent channel compensation device wants to amplify (which is the CH30 TV transmitter in this embodiment), so that the receiving antenna can receive the strongest CH30 main tower signal as possible; finally install the transmitting antenna of the CH30 adjacent channel compensation device, and its directivity is mainly determined by the area that needs to be enhanced; at this time, you can slightly adjust the angle of the receiving antenna of the CH30 adjacent channel compensation device, and coordinate with the test equipment, while fine-tuning the receiving antenna, at the same time by comprehensively measuring the signal strength and signal-to-noise ratio, and determine at which angle of the antenna toward the main tower signal it can receive the most and best signal from the main tower and least echo from its own transmitting antenna of the CH30 adjacent channel compensation device, so as to finally determine the orientation and angle of the receiving antenna of the CH30 adjacent channel compensation device.
Step 4. In the overlapping areas between the intended coverage of the LTE user equipment and the coverage of the lower adjacent channel authorized signal, test the reception of the lower adjacent channel authorized signal to confirm that in the entire overlapping area, the coverage and reception of CH30 have not changed before and after the LTE user equipment is installed. In this embodiment, the CH30 can be received normally before the LTE user equipment is installed; after the LTE user equipment is installed, the effect on the adjacent channel CH30 is as follows: 23 dBm−30=−7 dBm, and further, because the interference detection module and the interference cancellation module are added into the CH30 adjacent channel compensation device, let's assume the residual interference is reduced to 25% of the original, that is, the residual adjacent channel interference is −7 dBm−6=−13 dBm. Also, the output power of CH30 is 33 dBm after adding the adjacent channel compensation device. Because when the antennas are set up, a variety of methods are used to increase the isolation between the respective antennas, so it is considered that the signals received by the respective receiving antennas are relatively clean (the interference between each other is limited), and only the adjacent channel interference is considered. Its signal-to-noise ratio is approximately equal to 33 dBm−(−13 dBm)=46 dB, which exceeds its reception threshold (16 dB), and is 6 dB higher than before the introduction of interference cancellation. Therefore, it is determined that the transmission power set by the lower adjacent channel compensation device is sufficient to compensate for the deterioration of the LTE user equipment on its lower adjacent channel, and the introduction of increased antenna isolation and interference cancellation methods effectively increases the reception margin and improves the output signal-to-noise ratio.
Step 5. In the intended coverage area of the LTE user equipment, test its reception to confirm whether the coverage requirements are met. In this embodiment, the measurement of the CH30's adjacent channel influence on CH31 is 33 dBm−45 dB=−12 dBm, but because the CH31 LTE user equipment adds an interference detection module and interference cancellation module to handle the interference of the CH30 adjacent channel compensation device, let's say the residual interference is reduced to 50% of the original, so the residual adjacent channel interference is now −12 dBm−3=−15 dBm. In addition, because when the antennas are set up, a variety of methods are used to increase the isolation between the respective antennas, so the signals received by the respective receiving antennas are considered to be relatively clean (limited interference between each other), and only adjacent channel interference is considered here. Therefore, compared with the 23 dBm transmission power of LTE user equipment, its signal-to-noise ratio is approximately equal to 23 dBm−(−15 dBm)=38 dB, which exceeds the signal-to-noise ratio threshold (−3 dB) of LTE user equipment, and also it is 3 dB higher than before the introduction of interference cancellation; therefore, it is determined that the transmission power set by the lower adjacent channel compensation device will not affect the coverage and reception of the LTE user equipment, and the increase in antenna isolation and interference cancellation methods effectively increase the reception margin and increase the output signal-to-noise ratio.

### Embodiment 2

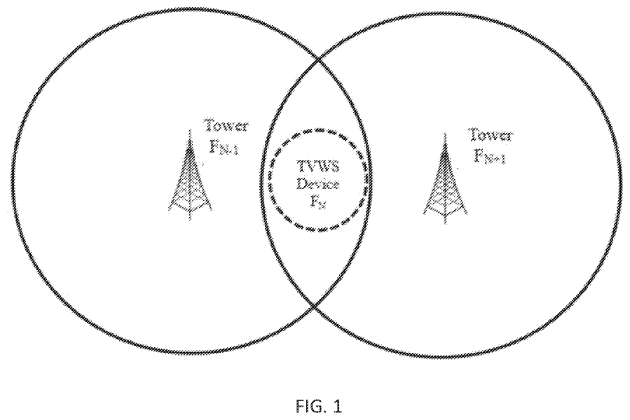

This embodiment relates to a power compensation method based on white space optimization and utilization technology. The application environment is shown in FIG. 1, and the white space device is to be installed in the overlapping areas authorized by two television broadcasting transmitters.

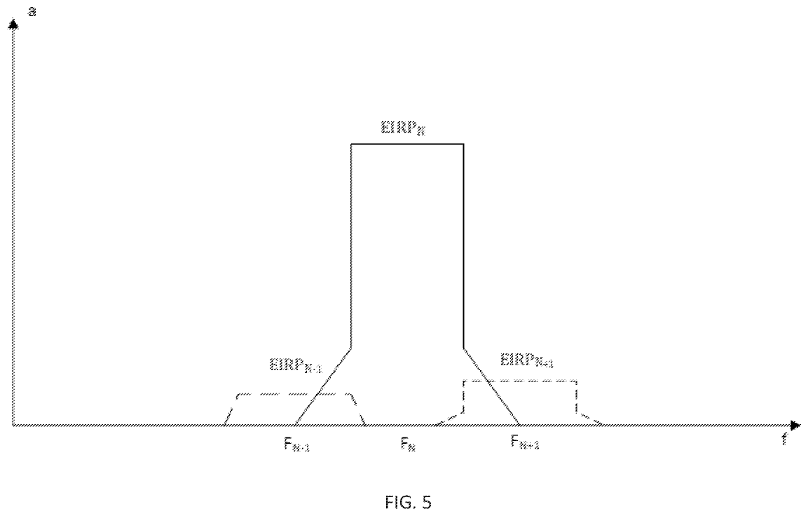

This embodiment specifically includes the following steps:
Step 1. According to the application, it is necessary to realize the signal coverage of the white space device within the dashed circular area shown in FIG. 1. In this embodiment, the white space device is an LTE base station, and the radius of the dashed circular area is 1000 meters, the LTE base station is installed at the center of the circle, the planned effective omnidirectional radiation power is EIRP=20 w (i.e., 43 dBm), and the proposed height of the antenna is 25 meters.
Step 2. According to the above LTE base station installation information, find the available white space channel in the known spectrum utilization database, for example, CH15, and the maximum EIRP corresponding to the license is 25 w, which can meet the requirements of LTE base station's intended transmission power. First, measure the floor noise of CH15 at the LTE base station installation point, which is −85 dBm. Knowing that the intended transmission power of the LTE base station is 43 dBm, the engineering design reception margin is 30 dB, and the reception threshold is 1.5 dB, then 43−(−85)=128>1.5+30, then it is determined that the white space frequency CH15 is useable, so at the LTE base station installation site, a trial transmission can be performed on the intended coverage area with an output power of 43 dBm.
Step 3. From FIG. 1, it can be seen that the intended coverage of the LTE base station is a subset of the authorized coverages of the two adjacent channels CH14 and CH16. From FIG. 5, the local signal strength of CH14 and CH16 is much lower than the LTE base station's intended output power, so the upper and lower adjacent channel signals need to be reasonably enhanced. The upper and lower thresholds for reasonable enhancement are determined by the following steps:
   a. According to the formula EIRP_{N+m}≥EIRP_{N}+R_{D/U-N+m}, EIRP_{N-m}≥EIRP_{N}+R_{D/U-N-m}, where in this embodiment, R_{D/U-N+m} and R_{D/U-N-m} are −33 dB. EIRP_{N}=43 dBm, so the lower limit of EIRP_{N+m} and EIRP_{N-m} is at least 43 dBm-33 dB=10 dBm.
   b. According to the formula EIRP_{N+m}≤P_{aj-N+m}+TH_{N+m} and EIRP_{N-m}≥P_{aj-N-m}+TH_{N-m}, where P_{aj-N+m}=EIRP_{N}−L_{N+m}, P_{aj-N-m}=EIRP_{N}−L_{N-m}. In this embodiment, EIRP_{N}=43 dBm. L_{N+m}=L_{N-m}=45 dB, TH_{N+m}=TH_{N-m}=16 dB. Then P_{aj-N+m}=−2 dBm; P_{aj-N-m}=−2 dBm. Therefore. EIRP_{N+m}≥−2 dBm+16 dB=14 dBm; EIRP_{N-m}≤−2 dBm+16 dB=14 dBm, so the lower limit of EIRP_{N+m} and EIRP_{N-m} are at least 14 dBm.
   c. According to the above steps 1) and 2), confirm that the EIRP of the CH14 and CH16 compensation device should not be less than 14 dBm.
   d. According to the formula EIRP_{N+m}≤EIRP_{N}−R_{D/U-N}, EIRP_{N-m}≤EIRP_{N}−R_{D/U-N}, where in this embodiment, R_{D/U-N} is −30 dB and EIRP_{N}=43 dBm, so the upper limit of EIRP_{N+m} and EIRP_{N-m} are at most 43 dBm+30 dB=73 dBm.
   e. According to the formula EIRP_{N+m}≤EIRP_{N}+L_{N+m-1}−TH_{N}; EIRP_{N-m}≤EIRP_{N}+L_{N-m+1}−TH_{N}, where in this embodiment, EIRPN=43 dBm, L_{N+m-1}=L_{N-m+1}=45 dB. TH_{N}=1.5 dB, and the upper limit of EIRP_{N+m} and EIRP_{N-m} is calculated to be at most 43 dBm+45 dB−1.5 dB=86.5 dBm.
   f. According to the above steps 4) and 5), confirm that the EIRP of the CH14 and CH16 compensation device cannot exceed 73 dBm.
   g. According to the above steps 1) to 6), the ranges of the transmission power can be obtained. In practical applications, it should be flexibly adjusted according to the needs, and sufficient margin should be guaranteed. Finally, in this embodiment, the EIRP of the CH14 and CH16 compensation devices is selected to be 43 dBm, which is the same as the intended transmission power of the white space device.
   h. In this embodiment, the adjacent channel compensation devices for CH14 and CH16 are added at the installation site of the LTE base station for signal enhancement. Specifically, set up the receiving antennas at CH14 and CH16 channels to receive the RF signals from the CH14 and CH16 main towers, amplify the signals, and then transmit through the same frequency (CH14 and CH16) transmitting antennas respectively. After the enhancement, the new EIRP is 43 dBm to realize the power compensation for the TV signal coverage of CH14 and CH16 in this area.

As shown in FIG. 3, in this embodiment, an interference measurement module and an interference cancellation module are added to the adjacent channel compensation device of CH14 and CH16 and the LTE base station respectively, where: the interference detection module in the adjacent channel compensation device and the LTE base station receive their local baseband digital signals and also obtain the transmitted signals as a reference from the LTE base station and the adjacent channel compensation device by connecting to their output via direct cables. Then by cross-correlation operation, it obtains the recovered interference signal and sends it to the interference cancellation module, while in the interference cancellation module, it subtracts the recovered interference signal from the local baseband digital signal so that it can output signals with interference eliminated for further process and transmission.

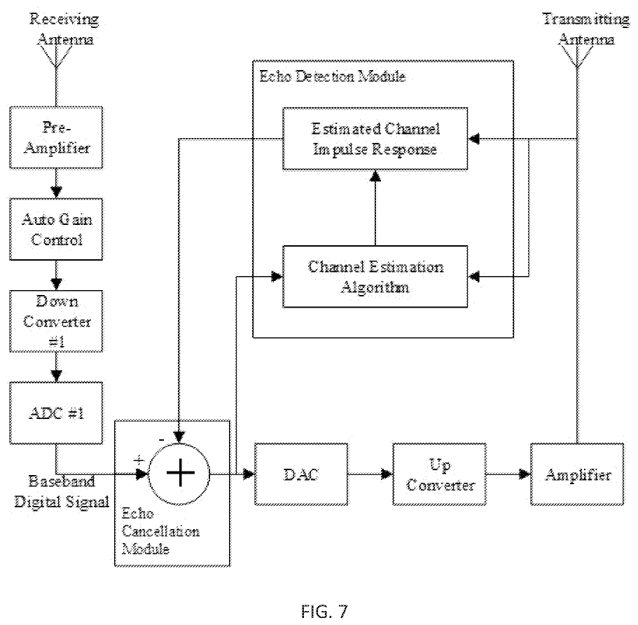

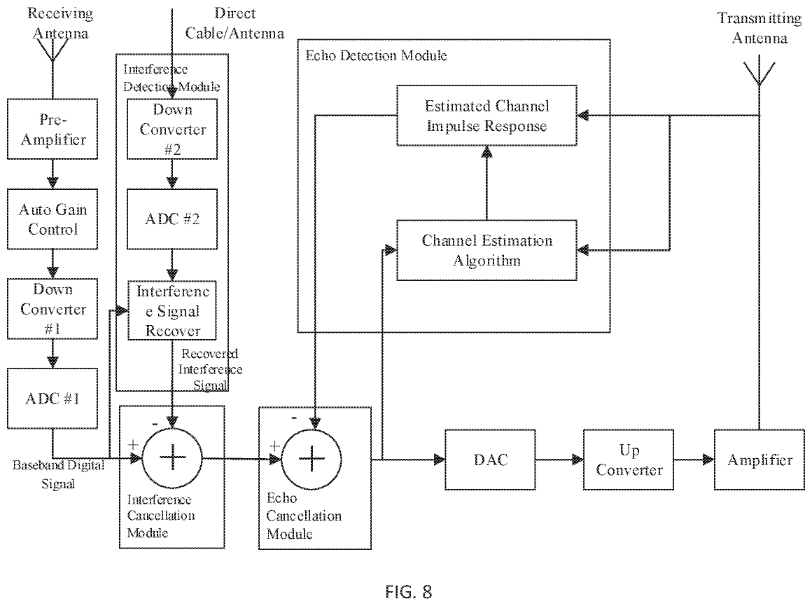

In the adjacent channel compensation device of CH14 and CH16, because they are transmitting at the same channel, and the system gain is also relatively large, to reduces the interference from the repeater's transmitting signal (echo) to the repeater receiving signals, and avoid the “self-oscillation”, an echo cancellation system is added to the adjacent channel compensation device of CH14 and CH16 respectively, to eliminate echoes in the output signal as much as possible. The structure of the adjacent channel compensation device of CH14 and CH16 with only the echo cancellation system is shown in FIG. 7. In the actual embodiment, the structure after adding the echo cancellation system and the interference detection/cancellation module at the same time is shown in FIG. 8.
Step 4. In the overlapping areas between the intended coverage of the white space device and that of the adjacent channel authorized signals, test the reception of the adjacent channel authorized signals to confirm that in the entire overlapping areas, the coverage and reception of CH14 and CH16 are unchanged before and after the LTE base station is installed. In this embodiment. CH14 and CH16 can be received normally before the LTE base station is installed; after the LTE base station is installed, its adjacent channel influence on CH14 and CH16 is 43 dBm−45 dB=−2 dBm. Furthermore, because the adjacent channel compensation device of CH14 and CH16 adds the interference detection module and the interference cancellation module, assuming that the interference is reduced to 50% of the original value, that is, the residual adjacent channel interference from the LTE base station is −2 dBm−3=−5 dBm. Also, the output power of CH14 and CH16 is 43 dBm after adding the adjacent channel compensation device, and it is believed that after the echo cancellation system, the output signal of the adjacent channel compensation device contains almost no echo, so the noise floor is only from adjacent channel interference caused by the LTE base stations. Therefore, the signal-to-noise ratio of CH14 and CH16 is approximately equal to 43 dBm−(−5 dBm)=48 dB, which exceeds their reception threshold (16 dB), and is 3 dB higher than before the introduction of interference cancellation. Therefore, it is determined that the transmission power set by the adjacent channel compensation device of CH14 and CH16 is sufficient to compensate for the deterioration of the LTE base station on its upper and lower adjacent channels, and the introduced interference cancellation method effectively increases the reception margin and improves the output signal-to-noise ratio.
Step 5. Test the reception of the white space device within its intended coverage area to confirm whether the coverage requirements are met. In this embodiment, the influence of CH14 and CH16 on their adjacent channel CH15 is 43 dBm−45 dB=−2 dBm. Furthermore, because the CH15 LTE base station has added the interference detection module and the interference cancellation module to handle the interference from CH14 and CH16 adjacent channel compensation device, assuming that the interference is reduced to 12.5% of the original, that is, the residual adjacent channel interference is −2 dBm−9=−11 dBm. Compared with the LTE base station's transmission power of 43 dBm, the LTE base station's signal-to-noise ratio is approximately 43 dBm−(−11 dBm)=54 dB, which exceeds the LTE reception threshold (1.5 dB), and the base station's signal-to-noise ratio is 9 dB higher compared with that before the introduction of interference cancellation. Therefore, it is determined that the transmission power set by the adjacent channel compensation device will not affect the coverage and reception of the LTE base station, and the introduced interference cancellation methods effectively increase the reception margin and improve the output signal-to-noise ratio.

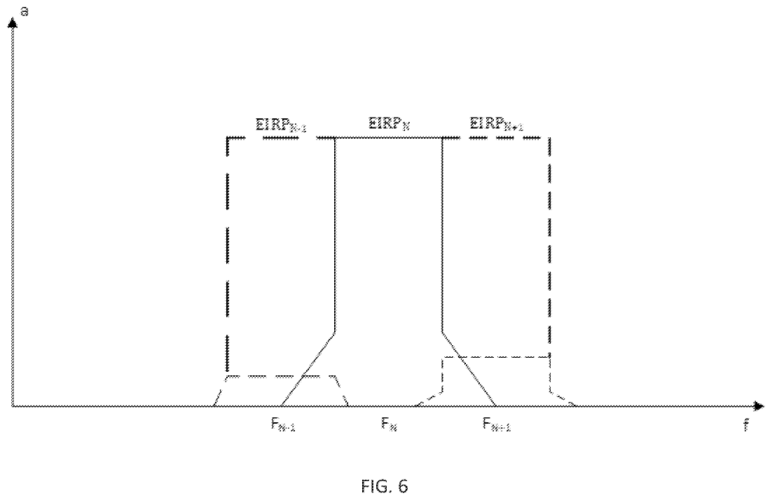

As shown in FIG. 6, the LTE base station and the adjacent-frequency compensation device are both built at the same place (the LTE base station installation point) and emit the same EIRP after the enhancement. Therefore, even if the transmission power is attenuated due to obstacles or distance, they have also nearly synchronous attenuation (far-near effect), which ensures that the signals of the three channels can work together within the intended coverage area of the LTE base station.

The above specific implementations can be locally adjusted by those skilled in the art in different ways without departing from the principle and purpose of the present invention. The protection scope of the present invention is subject to the claims and is not limited by the above specific implementations. All implementation schemes within the scope are bound by the present invention.

What is claimed is:

1. A power compensation method based on white space optimization and utilization technology, characterized in that by obtaining usable white space frequencies, and respectively enhancing the upper and/or lower adjacent channels correspondingly according to the relationship between the coverage of the white space device and its adjacent channel authorized signals, so that the white space device can reach the most of selectable frequencies and the maximum output power without affecting the existing adjacent channel authorized signals, and
the said enhancement performs feedforward removal of interference in the adjacent channel compensation device and the white space device, specifically: the interference signal obtained from the other party independently is used as a reference signal, and after the actual interference signal is recovered and subtracted from the respective baseband signal, it is used for transmission.

2. The power compensation method based on white space optimization and utilization technology according to claim 1, wherein the direct connection mode includes at least one of the following:
i) In the adjacent channel compensation device, the coupling output of the transmitted signal of the white space device is connected through a cable to the input of the adjacent channel compensation device as the RF interference reference signal;
ii) In the white space device, the coupling output of the transmitted signal of the adjacent channel compensation device is connected through a cable to the input of the white space device as the RF interference reference signal; and
iii) When there is more than one upper and/or lower adjacent channel compensation device, they are directly connected through respective cables to obtain RF interference reference signals of corresponding adjacent channels.

3. The power compensation method based on white space optimization and utilization technology according to claim 1, wherein the method of adding a reference receiving antenna facing the interference signal source includes at least one of the following:
i) Add a reference receiving antenna to the adjacent channel compensation device to obtain the transmitted signal of the white space device, and introduce the transmitted signal into the adjacent channel compensation device as an RF interference reference signal;
ii) Add a reference receiving antenna to the white space device to obtain the transmitted signal of the adjacent channel compensation device, and introduce the transmitted signal into the white space device as an RF interference reference signal; and
iii) When there is more than one upper and/or lower adjacent channel compensation device, the additional reference receiving antennas are used respectively toward the corresponding adjacent channel compensation device to obtain RF interference reference signals of the corresponding adjacent channels.

4. The power compensation method based on white space optimization and utilization technology according to claim 1, wherein the recovery of the interference signal refers to the baseband digital signal processing by the local receiving antenna and the reference signal received through the cable or the reference receiving antenna and converted to the digital domain, and the interference signal is recovered through but not limited to the correlation method.

5. The power compensation method based on white space optimization and utilization technology according to claim 1, wherein the subtraction processing refers to: directly subtracting the recovered interference signal from the local baseband digital signal, thereby obtaining an effective baseband with interference eliminated, converting it to the analog domain, and transmitting the signal out through the adjacent channel compensation device's antenna or the white space device's antenna.

6. The power compensation method based on white space optimization and utilization technology according to claim 1, wherein the self-excitation between the transmitting and receiving antennas can be eliminated by actively detecting the echo in the adjacent channel compensation device, specifically: The echo recovery signal is obtained by the echo detection module set at the transmitting antenna through the echo detection module set at the adjacent channel compensation device, and this recovered echo is subtracted from the baseband signal and then converted to the analog domain and output through the transmitting antenna.

7. The power compensation method based on white space optimization and utilization technology according to claim 1, wherein the horizontal isolation Lh and vertical isolation Lv among the transmitting and receiving antennas of the adjacent channel compensation device and the antenna of the white space device satisfying:
i) Lₕ=22.0+201 g(d₁/λ)—(Gₜ+Gᵣ)+(Dₜ₁+Dᵣ₁), where: 22.0 is the propagation constant; d₁ is the horizontal interval between the transmitting and receiving antennas (m); X is the working wavelength of the antenna (m); Gₜ, Gᵣ is the gain (unit:dB) of the transmitting and receiving antennas respectively; Dₜ₁ and Dᵣ₁ are the losses caused by the horizontal directivity function of the transmitting and receiving antennas respectively, and the specific values can be found in the antenna pattern, and when the angle of the transmitting and receiving antennas is 180°, the directivity loss is the front-to-back ratio of the antenna; and
ii) Lᵥ=28.0+401 g(d₂/λ)−(Gₜ+Gᵣ)+(Dₜ₂+Dᵣ₂), where: 28.0 is the propagation constant; d₂ is the vertical spacing between the transmitting and receiving antennas (unit: m); Dₜ₂ and Dᵣ₂ are the loss caused the vertical directivity of the two antennas and it is similar to the horizontal directivity function.

8. A power compensation device to realize the above method according to claim 1, characterized in comprising an interference detection module and an interference cancellation module respectively in the adjacent channel compensation device and the white space device, wherein: the interference detection module in the adjacent channel compensation device/white space device use a direct cable or an additional reference receiving antenna to obtain the RF signals from the transmitting antennas of the white space device or the adjacent channel compensation device as reference signals, while also receive the local baseband digital signal as input, and the recovered interference signal is obtained through cross-correlation and output to the interference cancellation module, and the interference cancellation module subtracts the recovered interference signal from the local baseband digital signal and outputs the baseband digital signal with interference eliminated to finally output to the transmitting antenna.

9. The power compensation device according to claim 8, wherein further comprises an echo cancellation system arranged in the adjacent channel compensation device, including an echo detection module and an echo cancellation module, wherein: the echo detection module generates the recovered echo signals and sends them to the echo cancellation module; the echo cancellation module subtracts the recovered echo signal from the baseband digital signal, then uses them for further processing and finally output to the transmitting antenna.

10. The power compensation device according to claim 9, wherein the echo detection module uses echo detection technology to obtain the recovered echo under the current channel circumstance by referring to the transmitted signal and the echo cancellation module's output, and the echo detection technology uses but is not limited to: the LMS Algorithm, NLMS algorithm, RLS algorithm, asynchronous correlation, or a combination of them.
